(19) United States
(12) Patent Application Publication
(10) Pub. No.: US 2006/0281633 A1
(43) Pub. Date: Dec. 14, 2006

(54) Method of making bamboo charcoal adsorbents

(76) Inventor: Chi-Hsiang Wang, Taipei City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/147,371

(22) Filed: Jun. 8, 2005

(51) Int. Cl. C01B 31/10

(52) U.S. Cl. 502/430

(57) ABSTRACT

A new method of making adsorbents from bamboo helps industry reduce pollution. The process involves preparing raw and/or waste bamboo for pyrolysis to produce bamboo charcoals and bamboo tar; crushing the bamboo charcoals into granular form, then mixing the grains with water and the bamboo tar; heating the resultant material in a rotary oven filled with an inert gas to produce carbonized charcoals; heating the carbonized charcoals in a gravity kiln, in which an activator is added and an inert gas is filled. This new method produces adsorbents with an unusually high capacity for physical and chemical adsorption.

### BACKGROUND OF THE INVENTION

1. Field of the Invention

The present invention relates generally to a process for producing adsorbents, and more particularly to a method of making bamboo charcoal adsorbents.

2. Description of the Related Art

Many industries produce volatile organic compounds (VOCs) that pollute the environment and increase human health risks. The common VOCs include hydrocarbon compounds and hydrocarbon compounds with oxygen, nitrogen, sulfur, and halogen, such as mercaptan, carbon tetrachloride, dimethyl sulfur, and so on. VOCs do most harm when they get into water or into the atmosphere. Industries generally employ adsorbents to remove such VOCs from wastewater or waste gas. Adsorbents do this by adsorbing most of these harmful compounds from water or gas until they reach saturation.

The adsorption capacity of the adsorbents comes from the affinity of molecules, and is classified into physical adsorption, chemical adsorption, and catalytic action. Generally, adsorbents are made of Fuller's earth and activated clays, aluminum oxide base materials, silica gel, ion exchangers, magnesia base materials, activated carbon, and so on. Activated carbon is the most common adsorbent in wastewater and waste gas because it is cheaper, easier to use, and recyclable. Activated carbon also has superior performance in dealing with organic and toxic waste, such as chrome, ozone, pesticides, aromatic series, and heterocyclic compounds. As a result, activated carbon is broadly applied for adsorption in industry.

### SUMMARY OF THE INVENTION

The present invention is a method of making adsorbents which have a larger specific surface area, greater pore volume, and more functional groups to perform a greater degree of adsorption than other adsorbents.

This invention uses bamboo to make such adsorbents because bamboo is a readily renewable resource. On the one hand, it grows quickly and must be replaced at maturity to allow new plant growth; the average life cycle of bamboo is from five to six years. On the other hand, bamboo has a high rate of decay. For this reason, bamboo cannot be used in furniture or in buildings.

When carbonized, however, bamboo is ideally suited as an adsorbent. After processing, it has a large number of pores that can quickly and easily adsorb VOCs as well as moisture, odors, etc. Depending on what it adsorbs, carbonized bamboo when saturated can serve as a fertilizer. In some cases, the impurities it adsorbs can be burned off without destroying the adsorbent property, which means it can be further re-used.

Because it can adsorb moisture, activated carbonized bamboo can replace silica gel and other substances that for one reason or another are deemed unsuitable for use in, for example, the adsorption of humidity in shoe boxes. This is one of the many advantageous applications of activated carbonized bamboo.

The present invention, then, is a method of using raw or waste bamboo to make a potentially re-usable and recyclable adsorbent that directly benefits industry and indirectly benefits the environment in a number of ways. This method is embodied in a process that follows a specific set of steps: preparation, pyrolysis, crushing, combining, carbonizing, and activating of bamboo materials. Except for small amounts of escaping heat and low-toxic smoke, most wastes from this process are re-used in the process, making it an environmentally friendly process, as well. The detailed description of these steps follows below and is directly related to the figures and illustrations provided in the next section. However, these steps may be outlined as follows: a) selecting and cutting of bamboo materials; b) heating them to make bamboo charcoals; c) crushing the bamboo charcoals to form grains of uniform porosity, and then combining the grains with water and an adhesive to form charcoal materials; d) carbonizing the charcoal materials in an oven filled with an inert gas; and e) activating the carbonized charcoal materials in an oven, and adding to it an activator and an inert gas.

### BRIEF DESCRIPTION OF THE DRAWINGS

FIG. 1 is a flow chart of the preferred embodiment of the present invention.

FIG. 2 is a picture of the bamboo material under the microscope, showing the original pores in the bamboo.

FIG. 3 is a picture of the bamboo charcoal under the microscope after the pyrolysis step, showing some pores formed in the bamboo.

FIG. 4 is a picture of the charcoal material under the microscope after the activation step, showing a cross-section of a pellet.

FIG. 5 is a picture of a piece of a pellet under the microscope after the activation step, showing a small particle within the pellet.

FIG. 6 is a picture of a greatly magnified piece of a pellet under the microscope, showing the nano structure of the pellet.

### DETAILED DESCRIPTION OF THE INVENTION

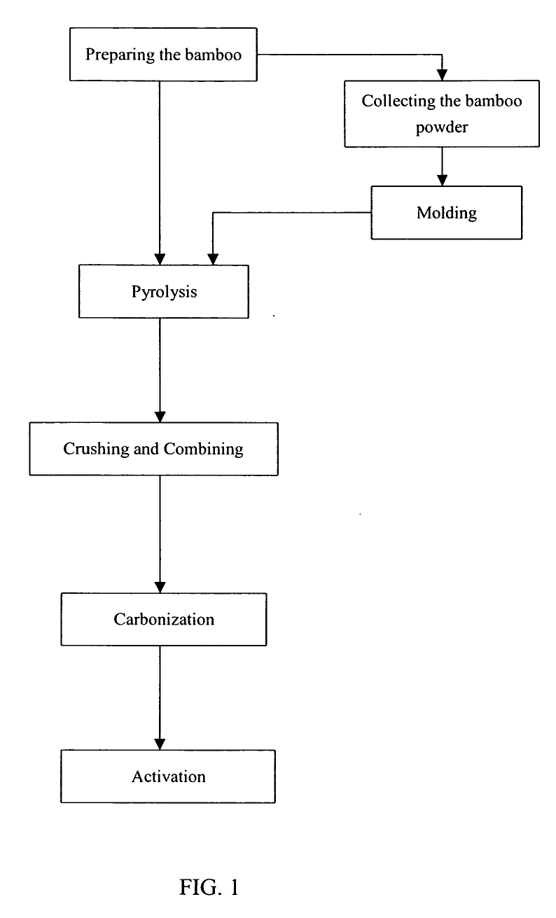

The present invention is a method of making bamboo charcoal adsorbents, as shown in FIG. 1. The preferred embodiment of this invention comprises five steps: preparation, pyrolysis, crushing and combining, carbonizing, and activating. These five steps are explained below, followed at the end by an example of one instance of the application of these steps.

a) Preparation:

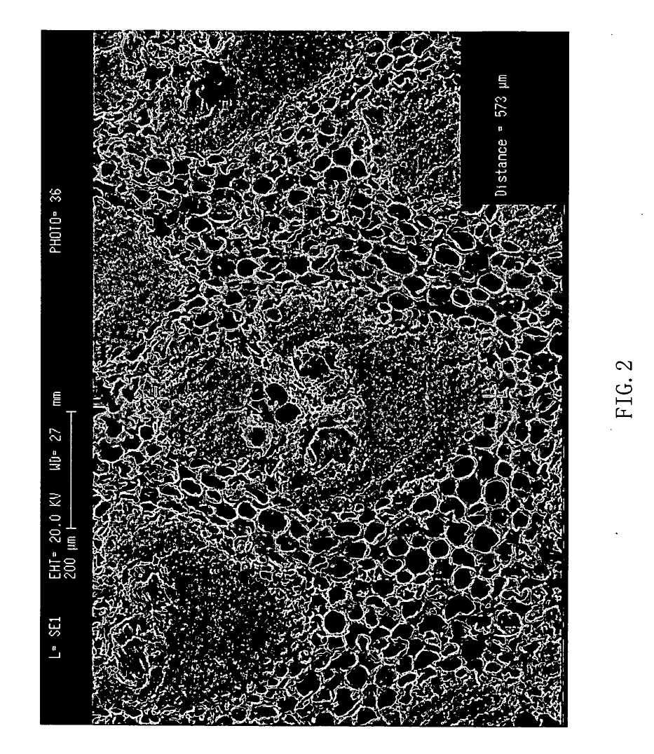

Practically any kind of bamboo can be processed by this method. In the case of raw bamboo (FIG. 2), it must be cut into pieces approximately 4 cm in diameter by 10 cm in length. In this state, the raw bamboo can skip the rest of the preparation and go directly to the pyrolysis step. Any left over materials are considered waste bamboo.

Because it meets the recycling requirement, the present invention prefers bamboo materials made from waste bamboo, which needs to be crushed to a fine granular or powder form within a range of 5 to 50 meshes. These materials are then extrusion molded to make blocks 6 cm in diameter×20 cm in length. Because the material within them has already been finely crushed, the molded blocks can be slightly larger than raw materials undergoing the same process.

The next step is to heat these bamboo materials uniformly.

b) Pyrolysis:

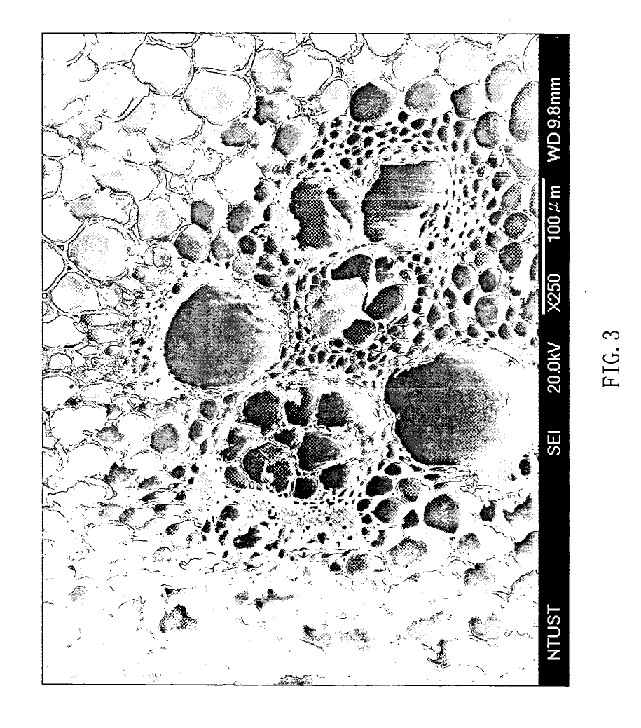

The bamboo materials are now sent to a distillatory oven to heat them between 500° C. to 700° C. for at least 40 hours. The main propose of the pyrolysis step is to transform the cellulose of the bamboo materials into bamboo charcoal and to remove unnecessary components thereof, such as water, hydrogen, oxygen, nitrogen, sulfur, acetic acid, and lignin, as shown in FIG. 3. The pyrolysis step also transforms pentosans of the bamboo materials into bamboo tar, which is a recyclable byproduct and can be used in the following step.

c) Crushing and Combining:

The bamboo charcoals that are produced by the pyrolysis step must next be sent to a vibration grinder to crush them into grains with widths in a range between 150 meshes and 250 meshes. The grains are then mixed with water and a predetermined adhesive to form a mixture. The resulting mixture of charcoal materials is put in a dry environment for approximately 72 hours (two to four days) to vaporize the water therein. The adhesive may be chosen from bamboo tar, hardwood tar, coal tar pitch, and asphalt, but the present invention prefers bamboo tar, which is formed during the pyrolysis step; this results in less waste and less pollution, further enhancing the present invention's usefulness in recycling. Once the materials have been combined in this way, the mixture is then sent to a twin spiral extruder to be molded into thousands of tiny pellets. This step effectively breaks down the pores of the cells of the charcoal materials and recombines them, resulting in a larger number of adsorbent pores than before.

d) Carbonization:

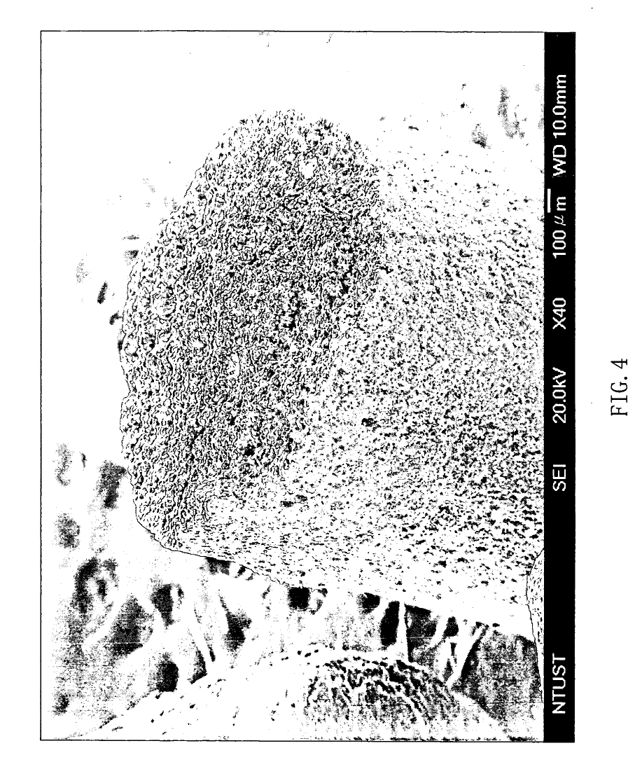

The charcoal materials in their small pellet form (FIG. 4) are now put into a rotary oven. The oven is then filled with an inert gas, such as nitrogen, to create sufficient pressure to keep out other gases or air from entering. The materials are then heated in the oven between 600° C. to 830° C. for at least 20 hours. This dries out the materials and removes any residues, such as tar-based adhesives, from them. Afterward, these carbonized materials must be cooled to a temperature between 170° C. to 240° C. before activation can take place. Once they have been cooled down, these carbonized materials are ready for activation.

The carbonization step also performs aromatization. This is needed because of the transformations of intermediate carbon-containing structures, which are formed from four-carbon fragments. This leads to polymerization of the four-carbon fragments appearing during the thermal degradation of anhydrocellulose. These reactions contribute to the formation of a condensed hexagonal network, which is called a turbostratic carbon structure, similar to graphite of aromatic planes, a number of which form crystallites similar to the small crystallite in graphite.

e) Activation:

The carbonized bamboo charcoals must next be moved to a special upright kiln, which uses gravity to carry on the remainder of the process. As the materials are put in the top of this kiln, they are mixed with an activator, such as water, vapor, carbon dioxide, air, or a mixture thereof. They are heated again, this time between 850° C. to 1050° C., for at least 45 hours. As before, an inert gas such as nitrogen must be added into the kiln to balance air pressure. At the end of the heating period, they automatically move down to the next level, where they are cooled to a temperature between 170° C. to 240° C. Finally, reaching the bottom of the kiln, they are taken out and cooled to room temperature.

The carbonized bamboo charcoals now are activated bamboo adsorbents.

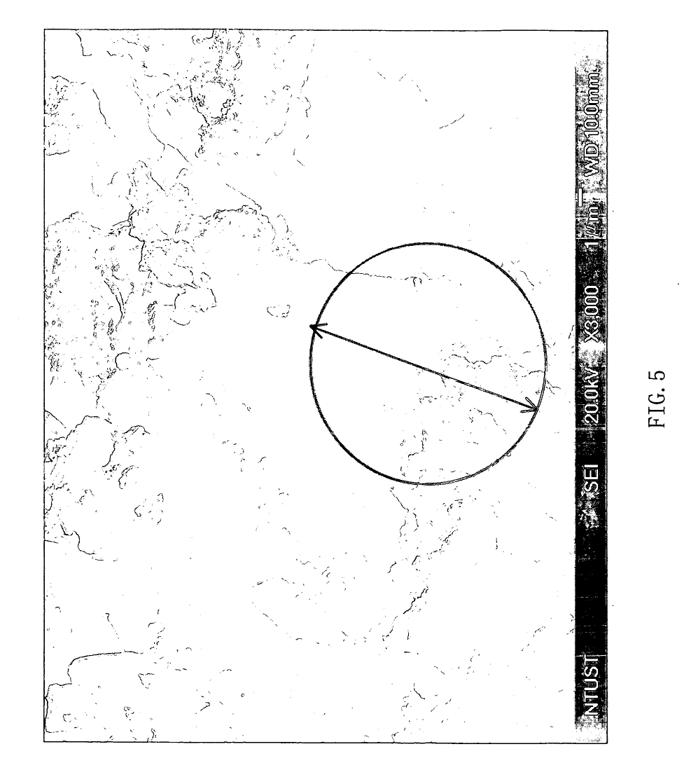

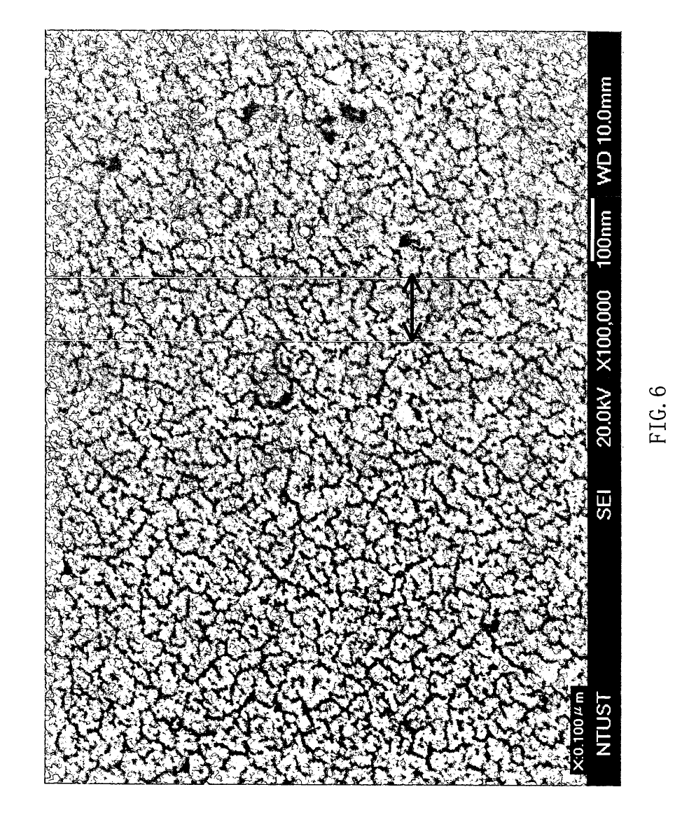

One of the advantages of this activation step is that it produces an increase in the volume of the material; it also breaks some bonds of the turbostratic carbon structures that form surface functional groups and it removes non-crystallized carbons from the bamboo charcoals. As a result, the bamboo adsorbents of the present invention have a high specific surface area and a high pore volume (FIG. 5 and FIG. 6); this means that the present invention has greater adsorbency than most if not all other materials.

The following is an example of the process, using a selected type of raw bamboo. In this example, specific details may differ slightly from the parameters of the general description above, but they fall within the preferred ranges.

### EXAMPLE

### Fabrication of Adsorbent Material from the Waste of Phyllostachys pubescens Mazel ex H. de Lehaie

This kind of bamboo has a moisture range of 60%˜80%, which affects the total amount of processing time, as seen below. The materials are first crushed into grains with sizes of 10 meshes to 30 meshes; next, the grains are extrusion molded into blocks. Afterwards these bamboo materials are put in a distillatory oven for the pyrolysis step. The oven heats the bamboo materials for 48 hours; the highest temperature of pyrolysis is about 600° C. Once the bamboo charcoals are formed and the bamboo tar is collected, the bamboo charcoals are crushed into grains with sizes of about 200 meshes, and then the grains are mixed with water and the bamboo tar. The mixture is molded by extrusion to form a large number of the charcoal materials. The charcoal materials are put outside for about two days until dry. After that, the charcoal materials are put in a rotary oven, in which nitrogen gas is filled, for the carbonization. The highest temperature of the carbonization is about 700° C., and the heating time is about 24 hours. After carbonization, the charcoal materials are cooled in the oven to about 200° C., and then they are sent to the gravity kiln for the activation step. Water is added into the gravity kiln to be the activator, and the gravity kiln is filled with nitrogen gas prior to heating. The highest temperature of the activation is about 950° C., and the heating time is about 48 hours. After activation, the charcoal materials are cooled in the gravity kiln down to 200° C. prior to being taken out. The activated charcoal materials are continuously cooled to room temperature. Finally, they are adsorbents.

The properties of the adsorbents are listed in the table hereunder:

TABLE

| Item(s) | Method(s) | Result(s) | | Remark(s) |
|---|---|---|---|---|
| BET surface area | ASTM D3663-92 | 1351 | m²/g | Underneath |
| Pore Volume | N₂ isothermal | 0.75 | cm³/g | Blank |
| | adsorption | | | |
| BJH desorption | N₂ isothermal | 28.97 | Å | |
| average diameter | adsorption | | | |
| Pore size | N₂ isothermal | as the attached | | |
| distribution | adsorption | | | |
| Adsorption ability | ASTM D3467-93 | 78.7 | wt % | |
| for CCl₄ | | | | |

| | | |
|---|---|---|
| Underneath Blank | Underneath Blank | Underneath Blank |

Surface Area

| | | |
|---|---|---|
| Single Point Surface Area at P/Po | 1301.0425 | m²/g |
| 0.20291986: | | |
| BET Surface Area: | 1351.1559 | m²/g |
| Langmuir Surface Area: | 1871.0587 | m²/g |
| BJH Adsorption Cumulative Surface | 616.0250 | m²/g |
| Area of pores between 17.000000 | | |
| and 3000.000000 Å Diameter: | | |
| BJH Desorption Cumulative Surface | 634.7645 | m²/g |
| Area of pores between 17.000000 | | |
| and 3000.000000 Å Diameter: | | |

Pore Volume

| | | |
|---|---|---|
| Single Point Total Pore Volume of | 0.747757 | cm³/g |
| pores less than 3535.4756 Å | | |
| Diameter at P/Po 0.99451759: | | |
| BJH Adsorption Cumulative Pore | 0.452653 | cm³/g |
| Volume of pores between 17.000000 | | |
| and 3000.000000 Å Diameter: | | |
| BJH Desorption Cumulative Pore | 0.459738 | cm³/g |
| Volume of pores between 17.000000 | | |
| and 3000.000000 Å Diameter: | | |

Pore Size

| | | |
|---|---|---|
| Average Pore Diameter | 22.1368 | Å |
| (4 V/A by BET): | | |
| BJH Adsorption Average Pore | 29.3918 | Å |
| Diameter (4 V/A): | | |
| BJH desorption Average Pore | 28.9706 | Å |
| Diameter (4 V/A): | | |
| Ratio of saturation adsorption of | 78.7 | wt % |
| carbon tetrachloride: | | |

Note:

According to the definition of the International Union of Pure and Applied Chemistry (UPAC), pores are classified according to their width into micropore (<2 nm), mesopore (2 nm˜50 nm), and macropore (>50 nm). Widths of the pores of the adsorbents of the present invention are in a range between 2 nm and 50 nm, which are the micropore and mesopore. The BET specific surface area is greater than 1300 m²/g, which provides a superior capacity of adsorption.

What is claimed is:

1. A method of making adsorbents, comprising the steps of:
a) preparing raw or waste bamboo materials for pyrolysis;
b) heating the bamboo materials (pyrolysis) to make bamboo charcoals;
c) crushing the bamboo charcoals to make fine grains, combining the fine grains with water and an adhesive, and forming charcoal materials;
d) carbonizing the charcoal materials by heating them in an oven filled with an inert gas; and
e) activating the carbonized charcoal materials by heating them in an oven, also filled with an inert gas, to which an activator is added.

2. The method as defined in claim 1, wherein step a) has the steps of preparing bamboo for pyrolysis either by gathering bamboo waste and forming it into blocks of a uniform size and shape or by cutting raw bamboo into pieces of a uniform size and shape.

3. The method as defined in claim 1, wherein step b) requires the heating of the previously prepared bamboo to be in a range between 550° C. and 700° C., and the time of heating to be at least 40 hours.

4. The method as defined in claim 1, wherein step c) has the steps of crushing the bamboo into grains, combining the grains with water and an adhesive, and molding the resultant mass into small pellets.

5. The method as defined in claim 1, wherein the dimensions of the grains in step c) are in a range between 150 meshes and 250 meshes.

6. The method as defined in claim 1, wherein the adhesive of step c) is chosen from among bamboo tar, hardwood tar, coal tar pitch, and asphalt.

7. The method as defined in claim 1, further comprising in step c) the step of drying the charcoal materials.

8. The method as defined in claim 1, wherein the heating in step d) takes place in a rotary oven (or furnace) in a range between 600° C. and 830° C., and the time of heating is at least 20 hours.

9. The method as defined in claim 1, wherein the carbonized charcoal materials in step d) are cooled in the rotary oven to a temperature between 170° C. to 240° C. prior to step e).

10. The method as defined in claim 1, wherein the highest temperature of heating in step e) is in a range between 850° C. and 1050° C., and the time of heating is at least 45 hours.

11. The method as defined in claim 1, wherein the activator in step e) is water.
